(19) United States
(12) Patent Application Publication
(10) Pub. No.: US 2013/0201367 A1
(43) Pub. Date: Aug. 8, 2013

(54) IMAGE ENCODING APPARATUS AND ITS CONTROL METHOD

(71) Applicant: CANON KABUSHIKI KAISHA, Tokyo (JP)

(72) Inventor: Hiroaki Endo, Hachioji-shi (JP)

(73) Assignee: CANON KABUSHIKI KAISHA, Tokyo (JP)

(21) Appl. No.: 13/753,932

(22) Filed: Jan. 30, 2013

(30) Foreign Application Priority Data
Feb. 8, 2012 (JP) 2012-025373
Dec. 27, 2012 (JP) 2012-285289

(51) Int. Cl. H04N 7/26

(52) U.S. Cl. CPC H04N 19/00569
USPC 348/231.99; 375/240.12

(57) ABSTRACT

Prediction image data corresponding to each of a plurality of different prediction methods is generated, an evaluation value of the prediction method is calculated, the prediction method corresponding to the evaluation value is evaluated on the basis of the calculated evaluation value, whether or not a corresponding prediction method is selected is determined on the basis of the evaluation result, and when the selection of the prediction method is determined, the decision of the selection based on the evaluation by an evaluating unit is not performed but the input image data is intra-picture encoded in accordance with the prediction method whose selection has been determined.

### BACKGROUND OF THE INVENTION

1. Field of the Invention

The present invention relates to an encoding apparatus for encoding an image and, more particularly, to an image encoding apparatus for selecting a plurality of intra-picture prediction methods and encoding a moving image.

2. Description of the Related Art

In the related art, a digital video camera has been well-known as a camera-integrated moving image recording apparatus which photographs an object and compression-encodes and records moving image data obtained by the photographing. In recent years, a recording medium for recording moving image data has been changed from a magnetic tape in the related art to a disk medium, a semiconductor memory, or the like having high use convenience such as random access performance or the like. As a compression method of an image, an MPEG2 method which can attain compression with a high compression rate by using inter-frame motion prediction is generally used. In recent years, an H.264 (another denomination: MPEG4-AVC) method which can attain compression with a high compression rate by using a more complicated prediction method or the like has also been used.

In H.264, there is an intra-picture prediction for predicting a pixel value of an encoding subject block by using values of peripheral pixels of the encoding subject block. In the intra-picture prediction, there are a plurality of prediction methods in which pixels which are used for prediction, ratios of addition of their pixel values, and the like differ. By properly selecting them, encoded data which has less deterioration of image quality even if high level compression is used can be generated. After all of the prediction methods were tried, if the prediction method to be used is decided, a large amount of arithmetic operation is necessary. Therefore, a study for selecting the proper prediction method by a small amount of arithmetic operation is widely made. According to the technique disclosed in the Japanese Patent Application Laid-Open No. 2006-005659, an image pattern of an encoding image is discriminated and by selecting the intra-picture prediction method on the basis of the image pattern, the proper prediction method is selected without trying all of the prediction methods.

Further, although a study of a next encoding method has been made in recent years, in order to raise a compression rate, processings are becoming further complicated. In the intra-picture prediction, like H.264, not only the prediction method using the values of the peripheral pixels of the encoded block but also various different prediction methods can be selected.

However, in the above related art, there is a case where it cannot sufficiently cope with the selection of various kinds of intra-picture prediction methods, so that there is such a problem that the proper prediction method cannot be selected. In order to select the proper prediction method, it is necessary to try all of the prediction methods. It results in an increase in arithmetic operation amount and, consequently, results in an overtime of an encoding processing time and wasteful electric power consumption.

### SUMMARY OF THE INVENTION

In consideration of the above problems, it is an aspect of the invention to provide an image encoding apparatus which can select a proper prediction mode even in the case where various kinds of different intra-picture prediction methods can be selected.

To accomplish the aspect of the invention, there is provided an image encoding apparatus, wherein a prediction method for generating prediction image data is selected from a plurality of different prediction methods, an intra-picture encoding to encode the input image data is executed, the prediction image data corresponding to each prediction method is generated, an evaluation value of the prediction method is calculated, the prediction method corresponding to that evaluation value is evaluated on the basis of the calculated evaluation value, whether or not a corresponding prediction method is selected is determined on the basis of a result of the evaluation, and when the selection of the prediction method is decided, the decision of the selection based on the evaluation by an evaluating unit regarding the other prediction methods is not performed but the input image data is intra-picture encoded in accordance with the prediction method whose selection has been decided.

Further features of the present invention will become apparent from the following description of exemplary embodiments with reference to the attached drawings.

### BRIEF DESCRIPTION OF THE DRAWINGS

FIG. 1 is a block diagram illustrating a construction of an image pickup apparatus having an image encoding apparatus according to the first embodiment of the invention.

FIG. 2 is a flowchart for an intra-prediction operation of the image encoding apparatus according to the first embodiment of the invention.

FIGS. 3A and 3B are schematic diagrams illustrating pixel arrays for describing different intra-picture prediction methods.

FIG. 4 is comprised of FIGS. 4A and 4B, showing a flowchart for an intra-prediction operation according to the second embodiment of the invention.

### DESCRIPTION OF THE EMBODIMENTS

The invention will be described hereinbelow with reference to the drawings on the basis of exemplary embodiments.

### First Embodiment

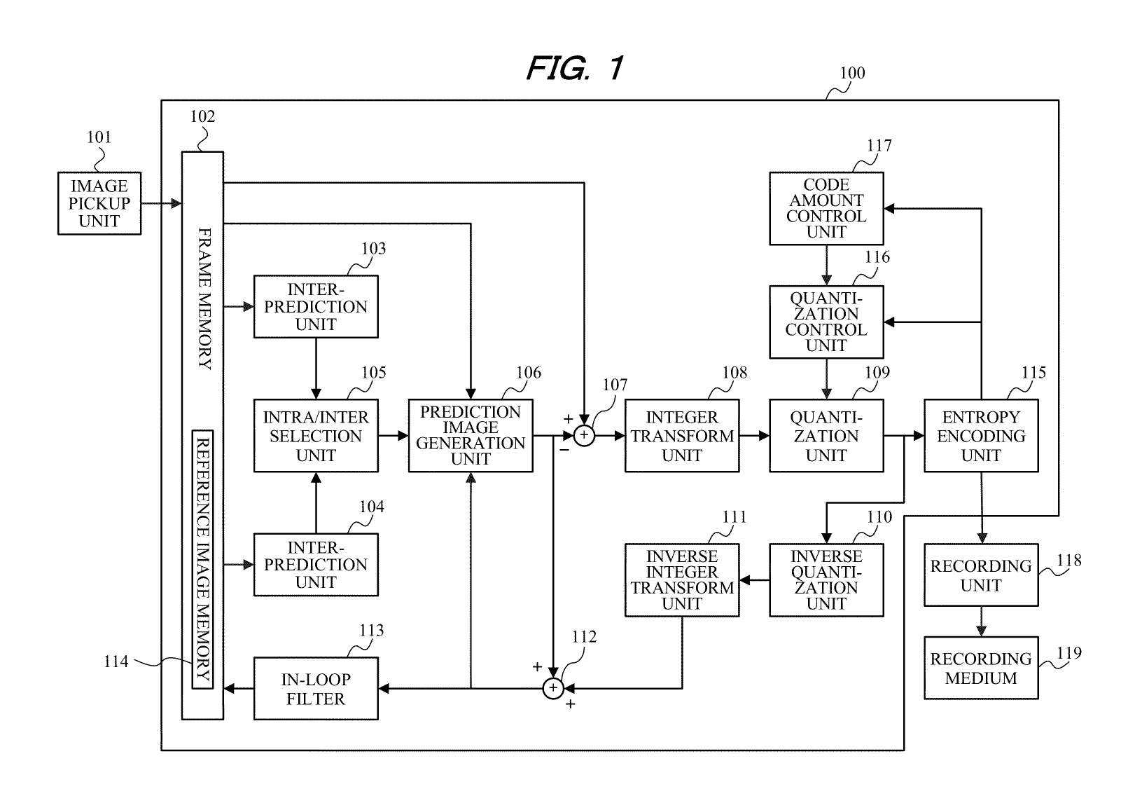

FIG. 1 is a block diagram illustrating an example of a construction of an image pickup apparatus including an image encoding apparatus 100 according to the embodiment. In the image pickup apparatus in FIG. 1, a construction which is not particularly concerned with the image encoding apparatus of the invention is omitted or illustrated in a simplified state.

In FIG. 1, the image pickup apparatus includes: the image encoding apparatus 100 according to the invention; an image pickup unit 101 which includes a camera unit such as lens, image sensor, and the like and obtains image data; and a recording unit 118. A recording medium 119 can be loaded to the image pickup apparatus. The image encoding apparatus 100 has: a frame memory 102; an inter-prediction unit 103 for searching for a moving vector; and an intra-prediction unit 104 for selecting an intra-prediction method. The image encoding apparatus 100 further has: an intra/inter selection unit 105 for selecting a prediction method of either an inter-prediction or an intra-prediction; a prediction image generation unit 106; a subtractor 107; an integer transform unit 108; and a quantization unit 109. The image encoding apparatus 100 further has: an inverse quantization unit 110; an inverse integer transform unit 111; an adder 112; an in-loop filter 113; an entropy encoding unit 115; a quantization control unit 116; and a code amount control unit 117. The frame memory 102 of the image encoding apparatus 100 has a reference image memory 114 for storing a reference image which is used in the inter-prediction or intra-prediction. Each component element of the image pickup apparatus including the image encoding apparatus 100 is controlled by a control unit (not shown) for controlling the whole image pickup apparatus. The control unit attains the control by loading and executing a program stored in a memory (not shown). This program also includes a control program for controlling the encoding operation of the image encoding apparatus of the invention, which will be described hereinafter. It is assumed that the image encoding apparatus 100 operates under the control by this program, unless otherwise specified. The image encoding apparatus 100 also includes a control unit and this control unit may attain the encoding operation of the present invention under the control by the control unit of the image pickup apparatus.

Moving image data obtained by photographing an object by the image pickup unit 101 is sequentially stored into the frame memory 102 in photographing order of the first frame, the second frame, the third frame, . . . . The image data is taken out of the frame memory 102 in encoding order of, for example, the third frame, the first frame, the second frame, . . . .

As an encoding method, there are an intra encoding (intra-picture encoding) for encoding only the image data in the frame and an inter encoding (inter-picture encoding) for encoding also including the prediction between the frames. As a picture which is subjected to the inter encoding, there are: a P picture for performing the prediction with one reference frame to a unit of motion compensation (referred to as an MC block); and a B picture for performing the prediction with up to two reference frames to the MC block. The picture which is subjected to the intra encoding is an I picture. The reason why the order of the frames to be encoded differs from the order of the frames which were input is to enable the prediction not only with the past frames but also with the frames which are future frames with respect to the time (backward prediction) to be performed.

In the case of performing the intra encoding, image data of an encoding subject block serving as an encoding unit is read out of the frame memory 102 and input to the intra-prediction unit 104. In the embodiment, it is assumed that one encoding subject block is constructed by 16 pixels (in the lateral direction)×16 pixels (in the vertical direction). Data of peripheral pixels of the read-out encoding subject block is also read out of the reference image memory 114 in the frame memory 102 and input to the intra-prediction unit 104.

The intra-prediction unit 104 selects the prediction method which corresponds to a plurality of different prediction methods, which will be described hereinafter, and is used to generate prediction image data from the input image data from the plurality of different prediction methods. Specifically speaking, on the basis of a correlation between the encoding subject block and a plurality of intra-prediction image data which is generated from the data of the peripheral pixels of the encoding subject block, the intra-prediction method that is optimum to the encoding subject block is selected and output to the intra/inter selection unit 105.

In the case of performing the intra encoding, the intra/inter selection unit 105 always selects the intra prediction and notifies the prediction image generation unit 106 of a selection result. In accordance with the prediction method selected by the intra/inter selection unit 105, the prediction image generation unit 106 generates intra-prediction image data from reconstructed image data which is output from the adder 112, which will be described hereinafter. As data of the peripheral pixels which is used by the intra-prediction unit 104, a reference image (reconstructed image data which is generated by the adder 112) may be used as mentioned above or original image data which is output from the frame memory 102 may be used.

The foregoing intra-prediction image data and the image data of the encoding subject block which is read out of the frame memory 102 are input to the subtractor 107, and image difference data of pixel values between the image of the encoding subject block and the intra-prediction image is output to the integer transform unit 108. The integer transform unit 108 performs an integer transformation to the image difference data of pixel values which was input. The quantization unit 109 executes a quantization processing to the signal which was transformed into an integer by the integer transform unit 108.

The entropy encoding unit 115 entropy-encodes a transformation coefficient which was quantized by the quantization unit 109 and outputs as a stream to the recording unit 118. A quantization coefficient in the quantization unit 109 is calculated by the quantization control unit 116 from an amount of codes generated in the entropy encoding unit 115, a target code amount which is set by the code amount control unit 117, and the like. The recording unit 118 records the stream which was output from the entropy encoding unit 115 onto the recording medium 119.

The transformation coefficient quantized by the quantization unit 109 is also input to the inverse quantization unit 110. The inverse quantization unit 110 inversely quantizes the transformation coefficient which was input. The inverse integer transform unit 111 performs an inverse integer transform processing to the signal which was inversely quantized.

The data which was inversely integer transformed and the intra-prediction image data which was generated by the prediction image generation unit 106 are input to the adder 112 and added. Data after the addition becomes decoded reconstructed image data, is input to the foregoing prediction image generation unit 106, and is used for generation of the intra-prediction image data. The reconstructed image data is subjected to a reduction processing of a block noise by the in-loop filter 113 and is stored into the reference image memory 114 as reference image data which is used at the time of the foregoing intra encoding and an inter encoding, which will be described hereinafter.

In the case of performing the inter encoding, the image data of the encoding subject block serving as an encoding unit is read out of the frame memory 102 and input to the inter-prediction unit 103. The inter-prediction unit 103 reads out the reference image data from the reference image memory 114, detects a motion vector from the image data of the encoding subject and the reference image data, and notifies the intra/inter selection unit 105 of the motion vector.

In dependence on the frame, either the inter-prediction or the intra prediction can be selected every encoding subject block. In the case of performing the intra encoding, the intra-prediction unit 104 operates as mentioned above and notifies the intra/inter selection unit 105 of a result of the intra prediction. The result of the inter-prediction unit 103 and the result of the intra-prediction unit 104 are input to the intra/inter selection unit 105. The intra/inter selection unit 105 selects, for example, the prediction method of the smaller difference value and notifies the prediction image generation unit 106 of the selected prediction method. The subtractor 107 calculates a difference between the image data of the encoding subject block and the prediction image data and generates image difference data. The image difference data is output to the integer transform unit 108. Subsequent processings are executed in a manner similar to those in the case of the intra encoding.

The operation of the intra-prediction unit 104 will be described in detail hereinbelow.

It is assumed that in the intra-prediction unit 104 in the embodiment, the following four kinds of intra-prediction methods are adaptively executed and one of them can be selected. The intra-prediction methods which can be applied to the embodiment are not limited to the following four methods but a plurality of methods may be used and the number of intra-prediction methods is not limited to four.

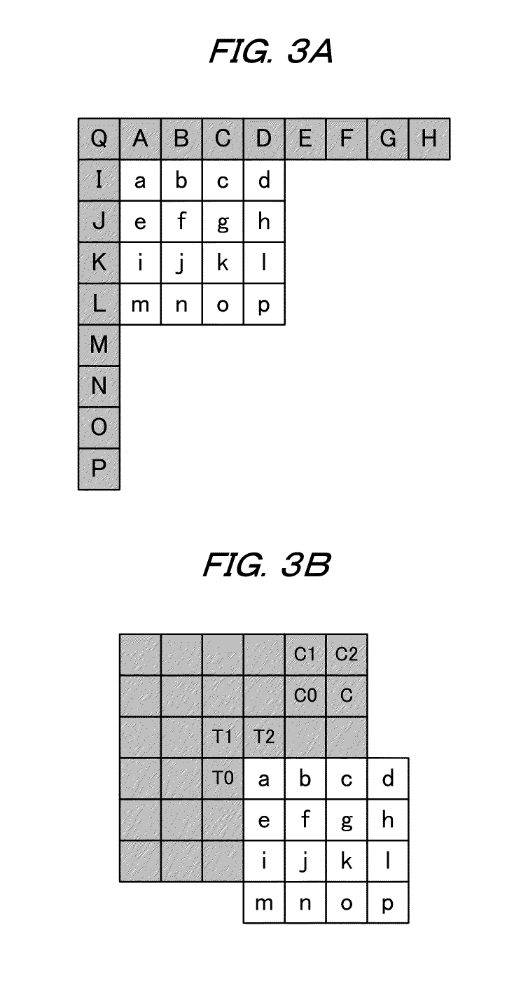

FIG. 3A is a schematic diagram of a pixel array for describing the intra-prediction method. It is assumed here that the encoding block is constructed by four pixels (in the horizontal direction)×four pixels (in the vertical direction). Reference characters a to p denote pixel values of the encoding block and A to Q indicate values of the pixels which belong to a neighborhood block and denote pixel values of the reconstructed image which has already been encoded. Prediction pixel values to be generated are indicated by a′ to p′. The prediction pixel values a′ to p′ become prediction image data.

Intra-Prediction Method 1: Arbitrary Directional Intra (Hereinbelow, ADI)

In the ADI, although the prediction image data is generated by using the pixel values A to Q, a plurality of kinds of generating methods of the prediction image data have been specified.

For example, a Vertical prediction mode as one of them will be described. In the Vertical prediction mode, the prediction in the vertical direction is performed and the prediction pixel values a′ to p′ are generated. That is, it is presumed that the pixel values a, e, i, and m are equal to the pixel value A, the pixel values b, f, j, and n are equal to the pixel value B, the pixel values c, g, k, and o are equal to the pixel value C, and the pixel values d, h, l, and p are equal to the pixel value D, respectively.

That is, the following pixel values are generated.

a′=e′=i′=m′=A

b′=f′=j′=n′=B

c′=g′=k′=o′=C

d′=h′=l′=p′=D

As mentioned above, in the ADI, the generation of the prediction image data is associated with the prediction direction. In the case of the prediction in the oblique direction, a′ to p′ are generated by weighted addition of A to Q. It is now assumed that the prediction mode (including a mean value prediction (DC prediction) having no directivity) in 34 directions including a horizontal direction having no directivity) can be selected.

Intra-Prediction Method 2: Multi-Parameter Intra (Hereinbelow, MPI)

In the MPI, the prediction image data is generated by applying filtering to the prediction image data generated by the ADI. In this instance, four pixels of the prediction pixel value of the ADI at a position of the prediction pixel value which is generated and the upper, right upper, and lower pixel values thereof are subjected to average filtering. For example, the prediction pixel value f′ of f is calculated as an average value of the prediction pixel values f′, b′, c′, and j′ of the ADI.

Intra-Prediction Method 3: Combined Intra Prediction (Hereinbelow, CIP)

In the CIP, the prediction image data is generated by the weighted addition of the prediction pixel value generated by the ADI and the average value of the values of the peripheral pixels. In this instance, the average value of the peripheral pixels is an average value of the left, left upper, and upper pixels and a weight of the prediction pixel value generated by the ADI is set to 70%. For example, a prediction pixel value f″ which is obtained by the CIP of f is calculated by the following equation.

f″=0.7×f′+0.3×((a+b+e)/3)

Intra-Prediction Method 4: Pixel Based Template Matching (Hereinbelow, PTM)

FIG. 3B is a schematic diagram of a pixel array for describing the prediction method of the PTM. In a manner similar to FIG. 3A, it is assumed that the encoding block is constructed by 4 pixels (in the horizontal direction)×4 pixels (in the vertical direction). Reference characters a to p denote the pixel values of the encoding block. Hatched pixels are pixels which belong to a neighborhood block and denote the reconstructed image which has already been encoded.

In the PTM, template matching of the peripheral pixels is performed and the pixel existing at a position having a highest correlation among them is assumed to be a prediction pixel. For example, in the case of calculating the prediction pixel value a′ of a, a pixel TO on the left side of a, a pixel T1 on the left upper side of a, and a pixel T2 on the upper side of a are used as templates. A search range where the template matching is performed is a hatched range in the diagram. For example, a height of correlation at a position of C is expressed by a sum of absolute difference which is calculated by the following equation.

SAD=|T0−C0|+|T1−C1|+|T2−C2|

The sum of absolute difference is obtained in the search range and the pixel value at a position where the sum of absolute difference is smallest is assumed to be a prediction pixel value. For example, assuming that the sum of absolute difference at the position of C is smallest, a′=C. Similarly, prediction pixels are obtained up to b′ to p′ and are set to a prediction image of the PTM.

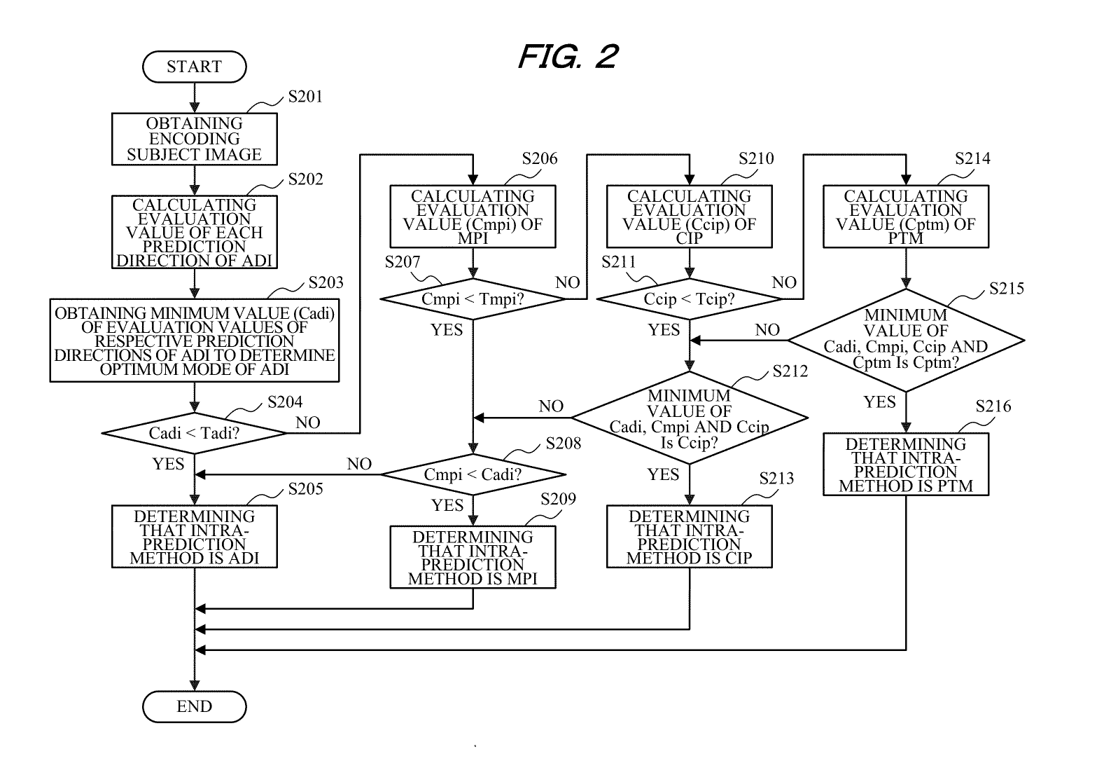

The operation of the intra-prediction unit 104 will be described with reference to a flowchart of FIG. 2.

In the embodiment, an evaluation about whether or not each prediction method is selectable is performed by comparing a magnitude relation between the sum of absolute difference between the input image data and the prediction image data and a threshold value which has been preset with respect to each prediction method. When the sum of absolute difference is smaller than the threshold value, the selection of the prediction method is decided. When it is larger than the threshold value, the evaluation of the next prediction method is performed. A selection construction of the prediction method in the embodiment uses a fundamental construction in which by repeating it, the optimum prediction method is selected. The threshold value can be set as a maximum sum of absolute difference (prediction error) which is permissible with respect to each prediction method. The selection construction of the prediction method in the embodiment will be described in detail hereinbelow.

In S201, the image of the encoding subject block is read out of the frame memory. First, the ADI is evaluated as a predetermined prediction method which is preferentially used in the embodiment. In S202, while the prediction images in the 34 prediction directions of the ADI are sequentially generated, an evaluation value corresponding to a difference amount between the encoding subject image data and the prediction image data is calculated with respect to each prediction direction. The evaluation value is calculated by an evaluation value calculating unit provided in the intra-prediction unit 104. In this instance, the sum of absolute difference is used as an evaluation value and the evaluation value is calculated.

In S203, the prediction direction in which a minimum evaluation value (Cadi) among the evaluation values regarding each prediction direction is decided as an optimum mode of the ADI. The prediction method (direction) corresponding to each evaluation value is evaluated about whether or not each prediction method is selectable, by an evaluating unit provided in the intra-prediction unit 104.

In S204, the evaluation value (Cadi) of the optimum mode of the ADI and a preset first threshold value (Tadi) are compared. When the evaluation value is smaller, it is determined in S205 that the intra-prediction method is the ADI, and the selection operation is finished. The determination is performed by a deciding unit provided in the intra-prediction unit 104. At this time, it is set so that the selection based on the evaluation to the other prediction methods by the evaluating unit is not performed.

If the first threshold value is smaller in S204, prediction image data of the MPI is generated and an evaluation value (Cmpi) is calculated by the evaluation value calculating unit in S206.

In S207, the evaluation value (Cmpi) of the MPI and a second threshold value (Tmpi) are compared. When the evaluation value is smaller, the evaluation value (Cmpi) of the MPI and the evaluation value (Cadi) of the ADI are compared in S208. When the evaluation value (Cmpi) of the MPI is smaller, it is determined in S209 that the intra-prediction method is the MPI, and the selection operation is finished. If the evaluation value (Cadi) of the ADI is smaller, it is determined in S205 that the intra-prediction method is the ADI, and the selection operation is finished. That is, even if the MPI is evaluated, when the sum of absolute difference as an evaluation value of the MPI gives a prediction error larger than that of the ADI, the ADI is selected. A similar discrimination is also made in the evaluation and decision of the selection to the other prediction methods which are executed when the MPI is not evaluated in S208.

If the second threshold value is smaller in S207, prediction image data of the CIP is generated and an evaluation value (Ccip) is calculated in S210. In S211, the evaluation value (Ccip) of the CIP and a third threshold value (Tcip) are compared. When the evaluation value is smaller as a result of the comparison, the evaluation value of the CIP, the evaluation value of the MPI, and the evaluation value of the ADI are compared in S212. When the evaluation value of the CIP is smallest, it is determined in S213 that the intra-prediction method is the CIP, and the selection operation is finished. If the evaluation value of the CIP is not smallest, the evaluation values are compared in S208 as mentioned above and the intra-prediction method is determined.

If the third threshold value is smaller in S211, prediction image data of the PTM is generated and an evaluation value (Cptm) is calculated in S214. In S215, the evaluation value (Cptm) of the PTM, the evaluation value (Ccip) of the CIP, the evaluation value (Cmpi) of the MPI, and the evaluation value (Cadi) of the ADI are compared in S215. When the evaluation value of the PTM is smallest, it is determined in S217 that the intra-prediction method is the PTM, and the selection operation is finished. If the evaluation value of the PTM is not smallest, the evaluation values are compared in S212 as mentioned above and the intra-prediction method is determined.

By the above operations, the threshold values and the evaluating order are set with respect to all of selectable intra-prediction methods, so that the proper intra-method can be selected without trying all of the prediction methods. Therefore, according to the embodiment, even if the number of selectable intra-prediction methods increases, the proper intra-prediction method can be selected while reducing the arithmetic operation amount. A burden in the encoding processing of the encoding apparatus can be reduced.

The order of evaluating the intra-prediction methods is not limited to that shown in the embodiment.

Naturally, the image encoding apparatus of the invention can be applied to an image signal processing or the like of a recording processing of the input image data in an information processing apparatus such as a PC (personal computer) or the like. In this case, control of the image encoding in the embodiment can be realized by a method whereby a CPU of the information processing apparatus loads and executes an image encoding program stored in the memory.

### Second Embodiment

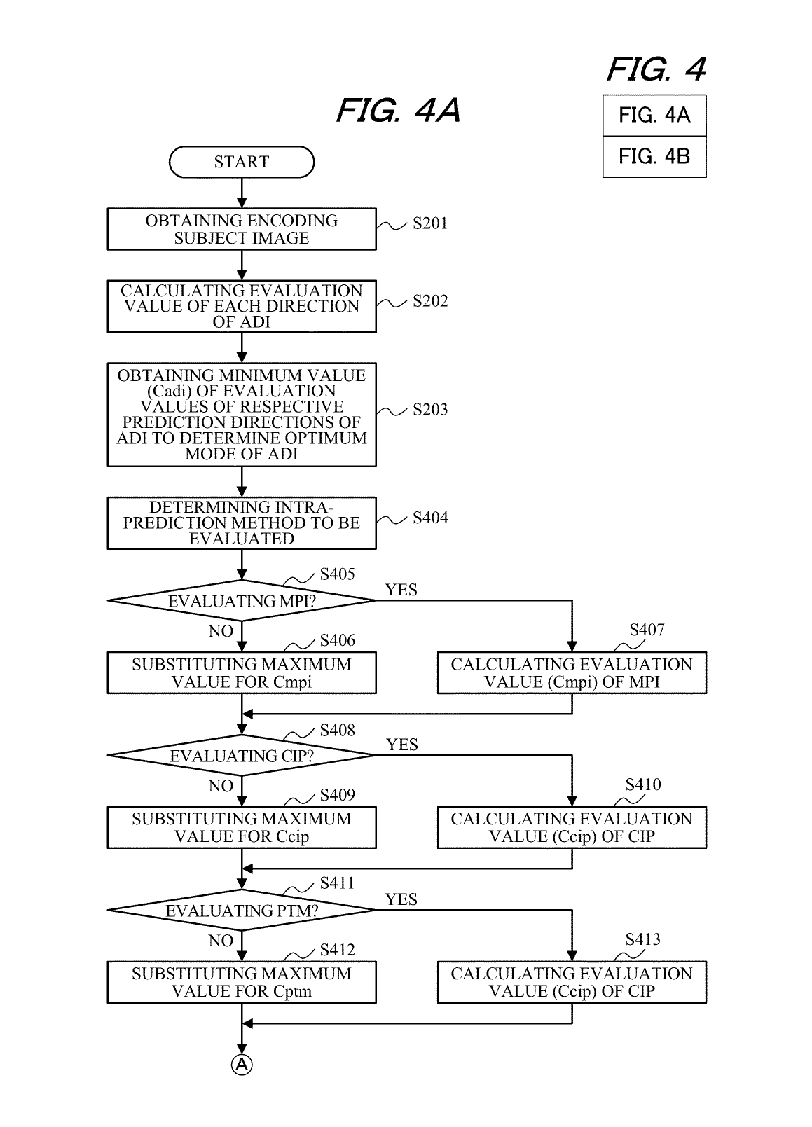

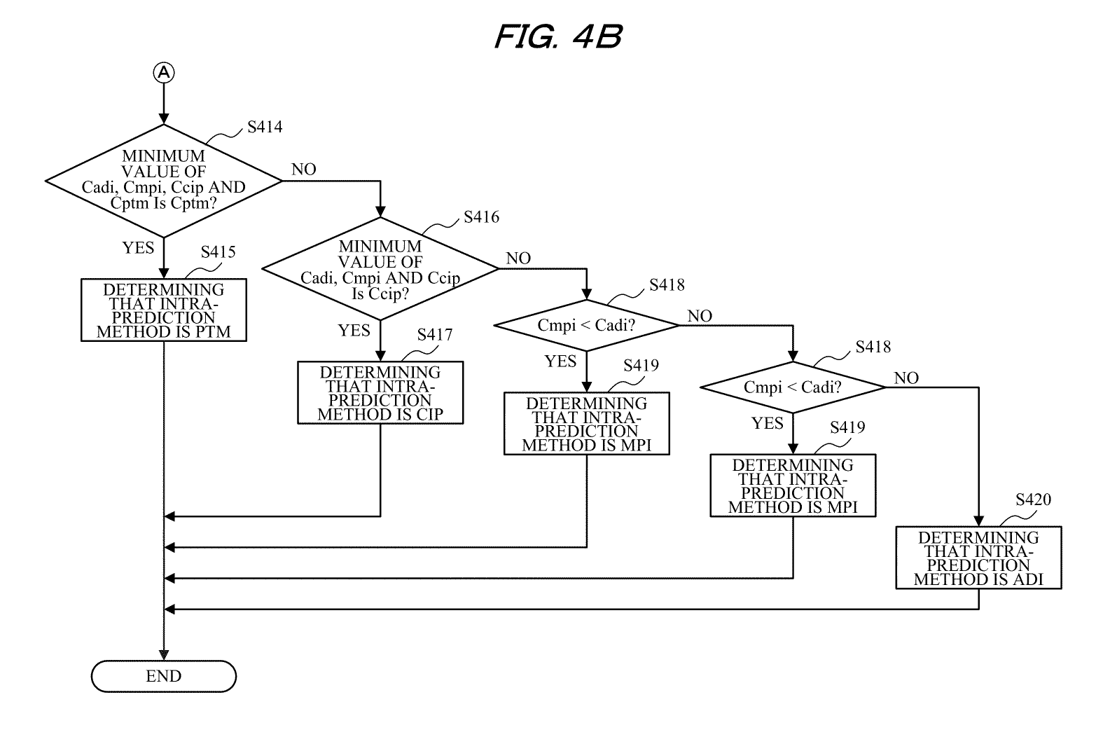

The second embodiment of the invention will now be described with reference to FIGS. 4A and 4B.

The embodiment provides a selection construction of the intra-prediction methods different from that of the first embodiment. Therefore, there is no change in the construction of the image pickup apparatus illustrated in FIG. 1 and its description is omitted here.

FIG. 4 is comprised of FIGS. 4A and 4B, showing a flowchart for describing the operation of the intra-prediction unit 104 in the embodiment. In the flowchart, the same processings as those in FIG. 2 are designated by the same reference numerals.

Although the evaluation of each prediction method has sequentially been performed in the first embodiment, in the second embodiment, for example, in consideration of a fact that the MPI and the CIP use the prediction pixel values of the ADI, the evaluation to the other prediction methods including the MPI and the CIP is set from the evaluation result of the ADI and their selection discrimination is simplified. The selection operation in the embodiment will be described in detail hereinbelow.

In S201, the image data of the encoding subject block is read out of the frame memory. In S202, while the prediction images in the 34 prediction directions of the ADI are sequentially generated, the evaluation value corresponding to the difference amount between the encoding subject image and the prediction image is calculated with respect to each prediction direction. In this instance, the sum of absolute difference is used as an evaluation value. In S203, the prediction direction in which the minimum evaluation value (Cadi) among the evaluation values regarding each prediction direction is decided as an optimum mode of the ADI. The processings until this step are similar to those in the first embodiment.

In S404, on the basis of the evaluation value of the ADI, the intra-prediction method to be evaluated after that is determined. First, the evaluation value (Cadi) of the ADI is compared with a preset threshold value. If the evaluation value of the ADI is larger as a result of the comparison, it is determined that “MPI is not to be subjected to evaluation, CPI is not to be subjected to evaluation, and PTM is to be subjected to evaluation”. On the other hand, if the evaluation value of the ADI is smaller than the threshold value, “MPI is to be subjected to evaluation, CPI is to be subjected to evaluation, and PTM is not to be subjected to evaluation”. The method of selecting the intra-prediction method to be evaluated is not limited to the foregoing example.

In S405, whether or not it has been determined in S404 that “MPI is to be subjected to evaluation” is discriminated. If it has been determined that “MPI is to be subjected to evaluation”, the evaluation value (Cmpi) of the MPI is calculated in S407. If it is not determined that “MPI is to be subjected to evaluation”, the maximum value (permissible maximum prediction error) which can be used as an evaluation value is set into the evaluation value of the MPI in S406.

In S408, whether or not it has been determined in S404 that “CIP is to be subjected to evaluation” is discriminated. If it has been determined that “CIP is to be subjected to evaluation”, the evaluation value (Ccip) of the CIP is calculated in S410. If it is not determined that “CIP is to be subjected to evaluation”, the maximum value which can be used as an evaluation value is set into the evaluation value of the CIP in S409.

In S411, whether or not it has been determined in S404 that “PTM is to be subjected to evaluation” is discriminated. If it has been determined that “PTM is to be subjected to evaluation”, the evaluation value (Cptm) of the PTM is calculated in S413. If it is not determined that “PTM is to be subjected to evaluation”, the maximum value which can be used as an evaluation value is set into the evaluation value of the PTM in S412.

In S414, the evaluation value of the PTM, the evaluation value of the CIP, the evaluation value of the MPI, and the evaluation value of the ADI are compared. If the evaluation value of the PTM is smallest, the PTM is determined as an intra-prediction method in S415 and the operation is finished.

If the evaluation value of the PTM is not smallest in S414, the evaluation value of the CIP, the evaluation value of the MPI, and the evaluation value of the ADI are compared in S416. If the evaluation value of the CIP is smallest, the CIP is determined as an intra-prediction method in S417 and the operation is finished.

If the evaluation value of the CIP is not smallest in S416, the evaluation value of the MPI and the evaluation value of the ADI are compared in S418. If the evaluation value of the MPI is smaller, the MPI is determined as an intra-prediction method in S419 and the operation is finished. On the other hand, if the evaluation value of the MPI is not smaller, the ADI is determined as an intra-prediction method in S420 and the operation is finished.

Even by the foregoing operation, in a manner similar to the first embodiment, the proper intra-prediction method can be selected without trying all of the selectable intra-prediction methods. The image encoding apparatus which can select the proper intra-prediction method while reducing the arithmetic operation amount can be provided.

### Other Embodiments

Each of the units constructing the recording apparatus in the embodiment of the invention mentioned above and each step of the recording method can be realized by a method whereby a program stored in a RAM, a ROM, or the like of a computer operates. Such a program and a computer-readable storage medium in which the program has been stored are also incorporated in the invention.

The invention can be also embodied, for example, as a system, an apparatus, a method, a program, or a storage medium. Specifically speaking, the invention can be also applied to a system constructed by a plurality of apparatuses or to an apparatus constructed by one equipment.

The invention also incorporates a case where a program (program corresponding to the flowcharts shown in FIGS. 2 and 4A and 4B in the embodiment) of software for realizing the functions of the embodiments mentioned above is supplied to a system or apparatus directly or from a remote place. The invention also incorporates a case where a computer of the system or apparatus reads out and executes a program code of the supplied program.

Therefore, the program code itself which is installed into the computer in order to realize the functions and processings of the invention also realizes the invention. The invention also incorporates the computer program itself for realizing the functions and processings of the invention. In such a case, the program may have any form such as object code, program which is executed by an interpreter, script data which is supplied to the OS, or the like so long as it has the function of the program.

As storage media for supplying the program, for example, there are a flexible disk, a hard disk, an optical disk, a magnetooptic disk, and the like. Further, there are also an MO, a CD-ROM, a CD-R, a CD-RW, a magnetic tape, a non-volatile memory card, a ROM, a DVD (DVD-ROM, DVD-R), and the like.

As another supplying method of the program, there is a method of connecting to a Homepage of the Internet by using a browser of a client computer. The program can be also supplied by downloading the computer program itself of the invention or a compressed file including an automatic installing function to a storage medium such as a hard disk or the like.

The program supplying method can be also realized by dividing the program code constructing the program of the invention into a plurality of files and downloading the respective files from different Homepages. That is, a WWW server for allowing a plurality of users to download the program file to realize the functions and processings of the invention by the computer is also incorporated in the invention.

As another method, the program supplying method can be also realized by a method whereby the program of the invention is encrypted and stored into a storage medium such as a CD-ROM or the like and distributed to the users, the user who can clear predetermined conditions is allowed to download key information to decrypt the encryption from the Homepage through the Internet, the encrypted program is executed by using the key information, and the program is installed into the computer.

The functions of the embodiments mentioned above are realized by a method whereby the computer executes the read-out program. Further, the functions of the embodiments mentioned above can be realized by a method whereby the OS or the like which operates on the computer executes a part or all of actual processings on the basis of instructions of the program and the functions are realized by the processings.

Furthermore, as another method, the functions of the embodiments mentioned above can be realized by a method whereby, first, the program read out of the storage medium is written into a memory provided for a function expanding board inserted into a computer or a function expanding unit connected to the computer, a CPU or the like provided for the function expanding board or function expanding unit executes a part or all of the actual processings on the basis of instructions of the program, and the functions are realized by the processings.

All of the foregoing embodiments are merely shown as specific examples to embody the invention and a technical scope of the invention is not limitedly interpreted by them. That is, the invention can be embodied by various forms without departing from the technical scope or a principal feature of the invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2012-025373 filed on Feb. 8, 2012, and 2012-285289 filed on Dec. 27, 2012, which are hereby incorporated by reference herein in their entirety.

What is claimed is:

1. An image encoding apparatus which can perform an intra-picture encoding, comprising:
an intra-prediction unit configured to correspond a plurality of different prediction methods and select a prediction method for generating prediction image data from the plurality of different prediction methods; and
an encoding unit configured to intra-picture encode input image data in accordance with the prediction method selected by the intra-prediction unit,
wherein the intra-prediction unit includes
an evaluation value calculating unit configured to generate the prediction image data corresponding to each of the prediction methods and calculate an evaluation value of the prediction method,
an evaluating unit configured to evaluate the prediction method corresponding to the evaluation value on the basis of the evaluation value calculated by the evaluation value calculating unit, and
a deciding unit constructed in such a manner that
whether or not a predetermined prediction method is selected is decided on the basis of the evaluation to the predetermined prediction method by the evaluating unit, and
if the selection of the predetermined prediction method is determined, it is set so that the selection based on the evaluation to the other prediction methods by the evaluating unit is not performed, and if the selection of the predetermined prediction method is not determined, the selection based on the evaluation to the other prediction methods by the evaluating unit is performed, and the prediction method is determined.

2. An apparatus according to claim 1, wherein the evaluation value calculating unit generates the prediction image data of the encoding subject image data in the input image data and calculates the evaluation value on the basis of a difference between the encoding subject image data and the generated prediction image data, and the evaluating unit compares the evaluation value with a preset threshold value, thereby evaluating whether or not the corresponding prediction method is selectable.

3. An apparatus according to claim 1, wherein the evaluation value calculating unit performs the calculation of the evaluation value according to each of the prediction methods in order which has been predetermined with respect to the plurality of prediction methods, and the evaluating unit and the deciding unit perform the evaluation about whether or not the corresponding prediction method is selectable and the determination of the selection based on the evaluation value each time the evaluation value calculating unit calculates the evaluation value.

4. An apparatus according to claim 3, wherein when the evaluation value calculating unit has calculated the evaluation values of at least two prediction methods, if the evaluating unit evaluates that the corresponding prediction method is selectable, the deciding unit determines the prediction method to be selected on the basis of the calculated evaluation values of at least the two prediction methods.

5. An apparatus according to claim 1, wherein when the evaluating unit evaluates that the prediction method is selectable with respect to all of the plurality of prediction methods, the deciding unit determines the prediction method to be selected on the basis of the evaluation value of each of the prediction methods calculated by the evaluation value calculating unit.

6. An apparatus according to claim 1, wherein when the selection of the corresponding prediction method is determined on the basis of the result of the evaluation by the evaluating unit, the deciding unit sets the evaluation about whether or not the other prediction methods in which the evaluation value is not calculated are selectable.

7. An apparatus according to claim 6, wherein when the evaluation value calculating unit calculates the evaluation value of the prediction method in which the evaluation showing that the prediction method is selectable has been set by the deciding unit among the other prediction methods and sets the evaluation value of the prediction method in which it has been evaluated that the prediction method is not selectable, and the deciding unit determines the prediction method to be selected on the basis of the evaluation value calculated by the evaluation value calculating unit and the set evaluation value.

8. An apparatus according to claim 1, wherein:
the predetermined prediction method is a direction prediction method including prediction of pixels in a vertical direction, a horizontal direction, and a plurality of oblique directions; and
the deciding unit preferentially evaluates the direction prediction method rather than the other prediction methods.

9. An apparatus according to claim 8, wherein the direction prediction method is an Arbitrary Directional Intra method.

10. An image pickup apparatus comprising:
an image pickup unit configured to photograph an object and obtain image data;
the image encoding apparatus according to claim 1; and
a recording unit configured to record the image data encoded by the image encoding apparatus onto a recording medium.

11. An image encoding method which is performed by an image encoding apparatus which can perform an intra-picture encoding, comprising:
an intra-predicting step of corresponding a plurality of different prediction methods and selecting a prediction method for generating prediction image data from the plurality of different prediction methods; and
an encoding step of intra-picture encoding the input image data in accordance with the prediction method selected by the intra-predicting step,
wherein the intra-predicting step includes
an evaluation value calculating step of generating the prediction image data corresponding to each of the prediction methods and calculating an evaluation value of the prediction method,
an evaluating step of evaluating the prediction method corresponding to the evaluation value on the basis of the evaluation value calculated in the evaluation value calculating step, and
a deciding step constructed in such a manner that
whether or not a predetermined prediction method is selected is decided on the basis of the evaluation to the predetermined prediction method by the evaluating step, and if the selection of the predetermined prediction method is determined, it is set so that the selection based on the evaluation to the other prediction methods by the evaluating step is not performed, and if the selection of the predetermined prediction method is not determined, the selection based on the evaluation to the other prediction methods by the evaluating step is performed, and the prediction method is determined.

12. A method according to claim 11, wherein the evaluation value calculating step includes generating the prediction image data of the encoding subject image data in the input image data and calculating the evaluation value on the basis of a difference between the encoding subject image data and the generated prediction image data, and the evaluating step includes comparing the evaluation value with a preset threshold value, thereby evaluating whether or not the corresponding prediction method is selectable.

13. A method according to claim 11, wherein the evaluation value calculating step includes performing the calculation of the evaluation value according to each of the prediction methods in order which has been predetermined with respect to the plurality of prediction methods, and the evaluating step and the deciding step include performing the evaluation about whether or not the corresponding prediction method is selectable and the determination of the selection based on the evaluation value each time the evaluation value is calculated in the evaluation value calculating step.

14. A method according to claim 13, wherein when the evaluation values of at least two prediction methods have been calculated in the evaluation value calculating step, if it is evaluated in the evaluating step that the corresponding prediction method is selectable, the deciding step includes determining the prediction method to be selected on the basis of the calculated evaluation values of at least the two prediction methods.

15. A method according to claim 11, wherein when it is evaluated in the evaluating step that the prediction method is selectable with respect to all of the plurality of prediction methods, the deciding step includes determining the prediction method to be selected on the basis of the evaluation value of each of the prediction methods calculated in the evaluation value calculating step.

16. A method according to claim 11, wherein when the selection of the corresponding prediction method is determined on the basis of the result of the evaluation by the evaluating step, the deciding step includes setting the evaluation about whether or not the other prediction methods in which the evaluation value is not calculated are selectable.

17. A method according to claim 16, wherein when the evaluation value calculating step includes calculating the evaluation value of the prediction method in which the evaluation showing that the prediction method is selectable has been set in the deciding step among the other prediction methods and setting the evaluation value of the prediction method in which it has been evaluated that the prediction method is not selectable, and the deciding step includes determining the prediction method to be selected on the basis of the evaluation value calculated in the evaluation value calculating step and the set evaluation value.

18. A method according to claim 11, wherein:
the predetermined prediction method is a direction prediction method including prediction of pixels in a vertical direction, a horizontal direction, and a plurality of oblique directions; and
the deciding step includes preferentially evaluating the direction prediction method rather than the other prediction methods.

19. A method according to claim 18, wherein the direction prediction method is an Arbitrary Directional Intra method.

20. A non-transitory computer-readable storage medium storing a program code for causing a computer to perform an image encoding in an image encoding apparatus which can perform an intra-picture encoding, comprising:
first program code means for corresponding a plurality of different prediction methods and selecting a prediction method for generating prediction image data from the plurality of different prediction methods; and
second program code means for intra-picture encoding the input image data in accordance with the prediction method selected by the first program code means,
wherein the first program code means comprises
third program code means for generating the prediction image data corresponding to each of the prediction methods and calculating an evaluation value of the prediction method,
fourth program code means for evaluating the prediction method corresponding to the evaluation value on the basis of the evaluation value calculated by the third program code means, and
fifth program code means constructed in such a manner that whether or not a predetermined prediction method is selected is decided on the basis of the evaluation to the predetermined prediction method by the fourth program code means, and if the selection of the predetermined prediction method is determined, it is set so that the selection based on the evaluation to the other prediction methods by the fourth program code means is not performed, and if the selection of the predetermined prediction method is not determined, the selection based on the evaluation to the other prediction methods by the fourth program code means is performed, and the prediction method is determined.
